(19) United States
(12) Patent Application Publication
(10) Pub. No.: US 2024/0377909 A1
(43) Pub. Date: Nov. 14, 2024

(54) DISPLAY DEVICE AND METHOD OF DRIVING THE SAME

(71) Applicant: Samsung Display Co., LTD., Yongin-si (KR)

(72) Inventors: Keum Dong JUNG, Yongin-si (KR); Jang Hui KIM, Yongin-si (KR); Ji Hoon KIM, Yongin-si (KR); Bo Hwan LEE, Yongin-si (KR)

(21) Appl. No.: 18/419,386

(22) Filed: Jan. 22, 2024

(30) Foreign Application Priority Data
May 10, 2023 (KR) 10-2023-0060491

(51) Int. Cl. G06F 3/041; G06F 3/0354; G06F 3/044

(52) U.S. Cl. CPC G06F 3/04184; G06F 3/03545; G06F 3/0441; G06F 3/0412

(57) ABSTRACT

A display device includes a display panel including a plurality of pixels, a display driver configured to display an image on the display panel in a frame period unit, to display the image on the display panel in a display period of the frame period, and to not display the image in a blank period of the frame period, a touch panel including touch electrodes, and a touch driver configured to sense a touch adjacent to the touch panel via the touch electrodes, and to transmit an uplink signal to an external device through the touch electrodes in a first time period, the first time period being in the blank period.

### CROSS-REFERENCED TO RELATED APPLICATION

The present application claims priority to and the benefit of Korean Patent Application No. 10-2023-0060491, filed on May 10, 2023, in the Korean Intellectual Property Office, the entire content of which is incorporated by reference herein.

### BACKGROUND

### 1. Field

Aspects of the present disclosure relate to an electronic device and a method of driving the same.

### 2. Description of Related Art

As a thickness of a panel becomes thinner, a parasitic capacitance may be formed between a panel electrode and a touch electrode, and such a parasitic capacitance may hinder transmission and reception of a signal between the touch electrode and an external device.

In order to solve such a problem, a method of increasing a driving voltage of an uplink signal has been proposed, but such a method is not preferred because an increase in the driving voltage causes an increase in power consumption.

The above description is only intended to help understanding of the background of the technical ideas of the present disclosure, and thus the above description may not be understood as the prior art known to those skilled in the art.

### SUMMARY

Aspects of embodiments of the present disclosure are directed to a system and method for improving reliability of a signal communicated between a display device and an active pen. For example, a signal characteristic of an uplink signal transmitted to an external device or an active pen may be improved without an increase in power consumption, and thus a display positioning system may be driven with improved reliability.

According to some embodiments of the present disclosure, there is provided a display device including: a display panel including a plurality of pixels; a display driver configured to display an image on the display panel in a frame period unit, to display the image on the display panel in a display period of the frame period, and to not display the image in a blank period of the frame period; a touch panel including touch electrodes; and a touch driver configured to sense a touch adjacent to the touch panel via the touch electrodes, and to transmit an uplink signal to an external device through the touch electrodes in a first time period, the first time period being in the blank period.

In some embodiments, the blank period includes a first porch period between a time point when the frame period starts and a time point when the display period starts, and a second porch period between a time point when the display period ends and a time point when the frame period ends, and the first time period is in the first porch period.

In some embodiments, the blank period includes a first porch period between a time point when the frame period starts and a time point when the display period starts, and a second porch period between a time point when the display period ends and a time point when the frame period ends, and the first time period is in the second porch period.

In some embodiments, in a second time period after the first time period, the touch driver is configured to receive a downlink signal from the external device through the touch electrodes.

In some embodiments, the first time period is part of a first frame period among a plurality of frame periods formed by repetition of the frame period, the blank period includes a first porch period between a time point when a corresponding frame period among the plurality of frame periods starts and a time point when the display period of the corresponding frame period starts, and a second porch period between a time point when the display period of the corresponding frame period ends and a time point when the corresponding frame period ends, the first time period is in the first porch period of the first frame period, and the second time period is in the second porch period of the first frame period.

In some embodiments, the first time period is part of a first frame period among a plurality of frame periods formed by repetition of the frame period, the blank period includes a first porch period between a time point when a corresponding frame period among the plurality of frame periods starts and a time point when the display period of the corresponding frame period starts, and a second porch period between a time point when the display period of the corresponding frame period ends and a time point when the corresponding frame period ends, the first time period is in the second porch period of the first frame period, and the second time period is in the first porch period of a second frame period immediately after the first frame period among the plurality of frame periods.

In some embodiments, the external device is an active pen, and the downlink signal includes at least one of a position coordinate of the active pen, button state information of the active pen, tilt information of the active pen, and battery state information of the active pen.

According to some embodiments of the present disclosure, there is provided a method of driving a display device including a display panel and a touch panel, the method including: sensing a touch adjacent to the touch panel; generating an uplink signal by encoding data associated with the sensed touch; and transmitting the uplink signal to an external device through touch electrodes of the touch panel in a first time period, wherein the first time period is in a blank period in which the display panel does not display an image.

In some embodiments, the display panel displays the image in a frame period unit, the frame period includes a display period in which the display panel displays the image and the blank period, the blank period includes a first porch period between a time point when the frame period starts and a time point when the display period starts, and a second porch period between a time point when the display period ends and a time point when the frame period ends, and the first time period is in the first porch period.

In some embodiments, the display panel displays the image in a frame period unit, the frame period includes a display period in which the display panel displays the image and the blank period, the blank period includes a first porch period between a time point when the frame period starts and a time point when the display period starts, and a second porch period between a time point when the display period ends and a time point when the frame period ends, and the first time period is in the second porch period.

In some embodiments, the method further includes: receiving a downlink signal from the external device through the touch electrodes of the touch panel in a second time period after the first time period.

In some embodiments, the first time period is part of a first frame period among a plurality of frame periods formed by repetition of the frame period, the blank period includes a first porch period between a time point when a corresponding frame period among the plurality of frame periods starts and a time point when a display period of the corresponding frame period starts, and a second porch period between a time point when the display period of the corresponding frame period ends and a time point when the corresponding frame period ends, the first time period is in the first porch period of the first frame period, and the second time period is in the second porch period of the first frame period.

In some embodiments, the first time period is part of a first frame period among a plurality of frame periods formed by repetition of the frame period, the blank period includes a first porch period between a time point when a corresponding frame period among the plurality of frame periods starts and a time point when a display period of the corresponding frame period starts, and a second porch period between a time point when the display period of the corresponding frame period ends and a time point when the corresponding frame period ends, the first time period is in the second porch period of the first frame period, and the second time period is in the first porch period of a second frame period immediately after the first frame period among the plurality of frame periods.

In some embodiments, the external device is an active pen, and the downlink signal includes at least one of a position coordinate of the active pen, button state information of the active pen, tilt information of the active pen, and battery state information of the active pen.

In some embodiments, the method further includes: transmitting a position coordinate corresponding to the touch extracted from the uplink signal received by the external device, and state information of the external device from the external device to a host via a wireless connection.

According to embodiments of the present disclosure, reliability of a signal communicated between the display device and the active pen may be improved.

Other aspects, features, and characteristics that are not described above will be more clearly understood from the accompanying drawings, claims, and detailed description.

### BRIEF DESCRIPTION OF THE DRAWINGS

The above and other features of the present disclosure will become more apparent by describing in further detail embodiments thereof with reference to the accompanying drawings, in which:

FIG. 1 is a block diagram illustrating a display device according to some embodiments of the present disclosure;

FIG. 2 is a block diagram illustrating a touch panel of FIG. 1, according to some embodiments of the present disclosure;

FIG. 3 is a block diagram illustrating a display driver and a display panel of FIG. 1, according to some embodiments of the present disclosure;

FIG. 4 is a timing diagram illustrating signals associated with the display driver of FIG. 3, according to some embodiments of the present disclosure;

FIG. 5 is a block diagram illustrating an uplink process according to some embodiments of the present disclosure;

FIG. 6 is a block diagram illustrating a downlink process according to some embodiments of the present disclosure;

FIG. 7 is a timing diagram illustrating the operation of the display device in the uplink process of FIG. 5, according to some embodiments of the present disclosure;

FIG. 8 is a timing diagram illustrating the operation of the display device in the uplink process of FIG. 5, according to some other embodiments of the present disclosure;

FIG. 9 is a timing diagram illustrating the operation of the display device in the downlink process of FIG. 6, according to some embodiments of the present disclosure;

FIG. 10 is a timing diagram illustrating the operation of the display device in the downlink process of FIG. 6, according to some other embodiments of the present disclosure.

FIG. 11 is a flowchart illustrating a method of operating a display device according to some embodiments of the present disclosure; and

FIG. 12 is a flowchart illustrating a method of operating an external device, according to some embodiments of the present disclosure.

### DETAILED DESCRIPTION

Hereinafter, a preferred embodiment according to the present disclosure is described in detail with reference to the accompanying drawings. It should be noted that in the following description, only portions necessary for understanding an operation according to the present disclosure are described, and descriptions of other portions are omitted in order not to obscure the subject matter of the present disclosure. In addition, the present disclosure may be embodied in other forms without being limited to the embodiment described herein. However, the embodiment described herein is provided to describe in detail enough to easily implement the technical spirit of the present disclosure to those skilled in the art to which the present disclosure belongs.

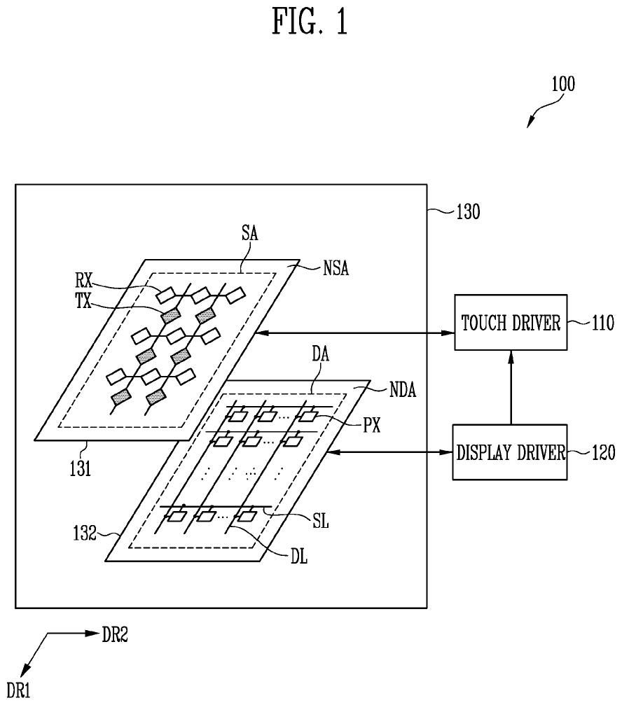

FIG. 1 is a block diagram illustrating a display device according to some embodiments of the present disclosure.

Referring to FIG. 1, a panel 130 may include a display panel 132 and a touch panel 131 overlapping the display panel 132.

In some embodiments, the display panel 132 and the touch panel 131 are separately manufactured and then coupled to overlap each other, at least partially. In other embodiments, the display panel 132 and the touch panel 131 are integrally manufactured. In this case, the touch panel 131 may be directly formed on at least one layer configuring the display panel 132, for example, an upper substrate, a thin film encapsulation layer, or an insulating layer of the display panel 132.

In FIG. 1, the touch panel 131 is disposed on the display panel 132, but the touch panel 131 is not limited thereto. For example, the touch panel 131 may be disposed under the display panel 132.

The display panel 132 may include a display area DA for displaying an image and a non-display area NDA around the display area DA. The non-display area NDA may at least partially surround the display area DA. The display panel 132 may include pixels PX formed on a substrate. The pixels PX may be disposed in the display area DA. In some embodiments, the substrate is a rigid substrate including a material such as glass or tempered glass. In other embodiments, the substrate is a flexible substrate including a material such as plastic or metal.

The pixels PX are connected to driving lines SL and data lines DL. The pixels PX are selected by a driving signal of a turn-on level supplied through the driving lines SL and receive data signals through the data lines DL. Accordingly, the pixels PX emit light of a luminance corresponding to the data signals, and an image is displayed in the display area DA.

Lines and/or an embedded circuit connected to the pixels PX may be disposed in the non-display area NDA. For example, a scan driver may be further disposed in the non-display area NDA.

In some embodiments, the display panel 132 includes pixels PX of organic light emitting elements (e.g., organic light emitting diodes), inorganic light emitting elements (e.g., inorganic light emitting diodes), quantum dot/well light emitting elements (e.g., quantum dot/well light emitting diodes), and/or the like. In other embodiments, the display panel 132 is implemented as a liquid crystal display panel. In this case, the display device 100 may additionally include a light source such as a back-light unit.

The touch panel 131 may include an active area SA capable of sensing a touch and a non-active area NSA around the active area SA. The active area SA may at least partially overlap the display area DA.

The touch panel 131 may include a substrate, and driving electrodes TX and sensing electrodes RX formed on the substrate. The driving electrodes TX and the sensing electrodes RX may be disposed in the active area SA on the substrate. In some embodiments, the substrate is a rigid substrate including a material such as glass or tempered glass. In other embodiments, the substrate is a flexible substrate including a material such as plastic or metal. In some embodiments, at least one layer configuring the display panel 132 is used as the substrate of the touch panel 131.

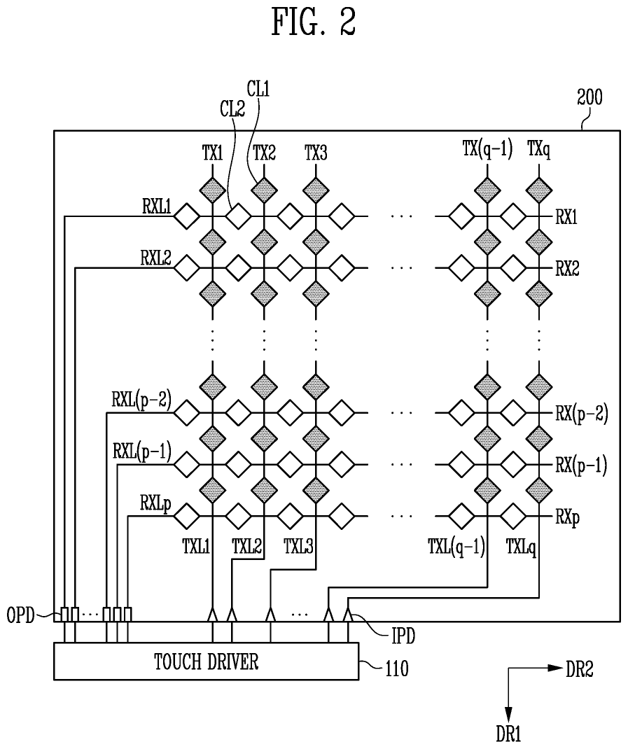

The touch panel 131 may be implemented as a touch panel 200 of FIG. 2.

In some embodiments, a display driver 120 and a touch driver 110 are configured as separate integrated chips (ICs). In other embodiments, the display driver 120 and the touch driver 110 are mounted in one IC.

The display driver 120 is electrically connected to the display panel 132 to drive the pixels PX. For example, the display driver 120 may include a data driver connected to data lines DL, a scan driver connected to drive lines SL, and a timing controller controlling the data driver and the scan driver. As another example, the display driver 120 may include the data driver and the timing controller, and the scan driver may be disposed in the non-display area NDA of the display panel 132.

The touch driver 110 may connected to the touch panel 131 to drive the touch panel 131 using a driving signal.

The display driver 120 may display an image on the display panel 132 in a display frame unit. The touch driver 110 may sense the touch in a sensing frame unit. A sensing frame period and a display frame period may be synchronized or asynchronous with each other.

FIG. 2 is a block diagram illustrating the touch panel of FIG. 1, according to some embodiments of the present disclosure.

Referring to FIG. 2, the touch panel 200 may include first to q-th driving electrodes TX1 to TXq and first to p-th sensing electrodes RX1 to RXp. The first to q-th driving electrodes TX1 to TXq may be connected to first to q-th driving lines TXL1 to TXLq, respectively. The first to p-th sensing electrodes RX1 to RXp may be connected to first to p-th sensing lines RXL1 to RXLp, respectively.

Each of the first to q-th driving electrodes TX1 to TXq may include first cells CL1 arranged in a first direction DR1 and electrically connected to each other, and each of the first to p-th sensing electrodes RX1 to RXp may include second cells CL2 arranged in a second direction and electrically connected to each other. In FIG. 2, each of the first cells CL1 and the second cells CL2 has a diamond shape. However, embodiments of the present disclosure are not limited thereto. For example, each of the first cells CL1 and the second cells CL2 may have at least one of various shapes such as a circular shape, a quadrangular shape, a triangular shape, and a mesh shape. In addition, the first cells CL1 and the second cells CL2 may be formed as a single layer or multiple layers. As described above, shapes and an arrangement of the first to q-th driving electrodes TX1 to TXq and the first to p-th sensing electrodes RX1 to RXp may be variously modified in a suitable manner.

In some embodiments, the first cells CL1 and the second cells CL2 exhibit conductivity by including at least one of various conductive materials such as a metal material and a transparent conductive material. For example, the first cells CL1 and the second cells CL2 may include at least one of various metal materials such as gold (Au), silver (Ag), aluminum (Al), molybdenum (Mo), chromium (Cr), titanium (Ti), nickel (Ni), neodymium (Nd), copper (Cu), platinum (Pt), or an alloy thereof.

The touch panel 200 may be provided as the touch panel 131 of FIG. 1.

The touch panel 200 may further include input pads IPD connected to the first to q-th driving lines TXL1 to TXLq. The touch driver 110 of FIG. 1 may be connected to the first to q-th driving lines TXL1 to TXLq through the input pads IPD.

The touch panel 200 may further include output pads OPD connected to the first to p-th sensing lines RXL1 to RXLp. The touch driver 110 may be connected to the first to p-th sensing lines RXL1 to RXLp through the output pads OPD.

The touch panel 200 may include first touch electrodes and second touch electrodes forming mutual capacitances with the first touch electrodes. The first touch electrodes may be provided as the first to q-th driving electrodes TX1, TX2, TX3, . . . , TX(q−1), and TXq (q is a positive integer). The second touch electrodes may be provided as the first to p-th sensing electrodes RX1, RX2, . . . , RX(p−2), RX(p−1), and RXp (p is a positive integer). The first to q-th driving electrodes TX1 to TXq may extend in the first direction DR1 and may be arranged spaced apart from each other in the second direction DR2. The first to p-th sensing electrodes RX1 to RXp may extend in the second direction DR2 and may be arranged spaced apart from each other in the first direction DR1. The first to p-th sensing electrodes RX1 to RXp may be electrically separated from the first to q-th driving electrodes TX1 to TXq while crossing the first to q-th driving electrodes TX1 to TXq, and may form a mutual capacitance with the first to q-th driving electrodes TX1 to TXq.

When a user's touch is provided to the touch panel 200, one or more of the mutual capacitances may change. For example, the touch may include at least one of various types of inputs that cause a change in a mutual capacitance, such as a user's physical contact (e.g., a user touch) or hovering. The touch driver 110 may recognize the touch by sensing such a change in the mutual capacitance.

The touch driver 110 is connected to the first to q-th driving electrodes TX1 to TXq through the first to q-th driving lines TXL1, TXL2, TXL3, . . . , TXL(q−1), and TXLq. The touch driver 110 is connected to the first to p-th sensing electrodes RX1 to RXp through the first to p-th sensing lines RXL1, RXL2, . . . , RXL(p−2), RXL(p−1), and RXLp.

The touch driver 110 may sense sensing signals from the first to p-th sensing electrodes RX1 to RXp through the first to p-th sensing lines RXL1 to RXLp while applying driving signals to the first to q-th driving electrodes TX1 to TXq through the first to q-th driving lines TXL1 to TXLq. The touch driver 110 may sense a change in the mutual capacitance based on the sensing signals.

In some embodiments, the first to q-th driving lines TXL1 to TXLq is divided into a plurality of driving line groups, and the touch driver 110 concurrently (e.g., simultaneously) applies the driving signals to driving lines included in one driving line group. For example, the touch driver 110 may employ a multi-channel driving method. While such a multi-channel driving method may reduce one sensing frame period, relatively large EMI may be caused due to concurrently (e.g., simultaneously) applied driving signals.

The concurrently (e.g., simultaneously) applied driving signals may be associated with an arbitrary encoding matrix. The touch driver 110 may sense the sensing signals through the first to p-th sensing lines RXL1 to RXLp, and sense a position of the touch by decoding the sensing signals based on a modulation matrix associated with the concurrently (e.g., simultaneously) applied driving signals. The modulation matrix may be obtained by encoding the above-described concurrently (e.g., simultaneously) applied driving signals.

The display device 100 of FIG. 1 may exchange a signal with an external device or an active pen through the touch electrodes. The touch driver 110 may supply an uplink signal to the touch electrodes, and the external device 300 may receive the uplink signal when the external device 300 is adjacent to the touch electrodes.

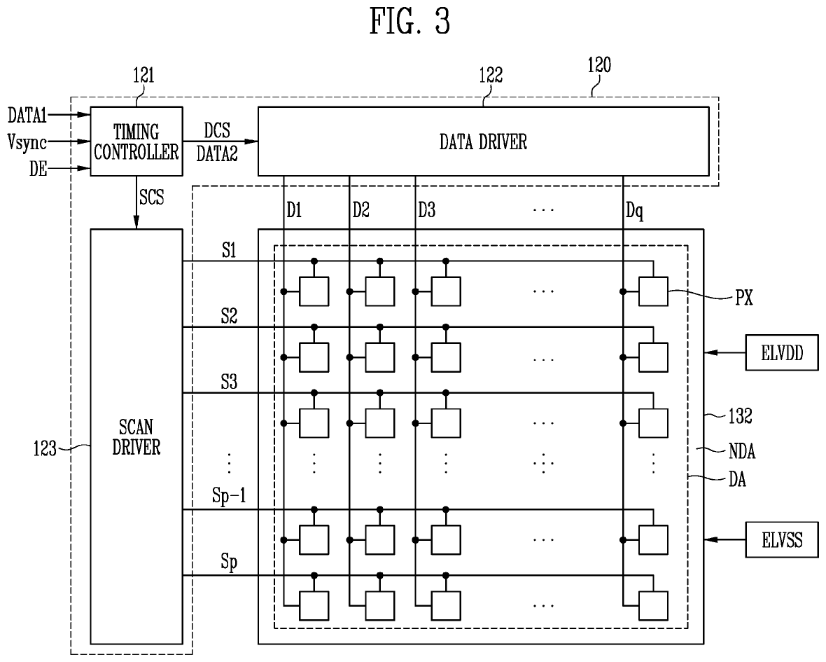

FIG. 3 is a block diagram illustrating the display driver and the display panel of FIG. 1, according to some embodiments of the present disclosure.

Referring to FIG. 3, the display device 100 according to some embodiments of the present disclosure includes the display panel 132 and the display driver 120.

The display panel 132 may include the pixels PX, and data lines D1 to Dq and scan lines S1 to Sq connected to the pixels PX.

The display panel 132 may include the display area DA for displaying an image and the non-display area NDA around the display area DA. The non-display area NDA may at least partially surround the display area DA.

Each of the pixels PX may be connected to first power source ELVDD and second power source ELVSS.

The pixels PX may include a light emitting element (for example, an organic light emitting diode), and may generate light corresponding to a data signal, by a current flowing from the first power source ELVDD to the second power source ELVSS via the light emitting element. The first power source ELVDD may be a high potential voltage, and the second power source ELVSS may be a low potential voltage.

The display driver 120 may include a scan driver 123, a data driver 122, and a timing controller 121.

The scan driver 123 may supply scan signals to the scan lines S1 to Sp in response to a scan driver control signal SCS. For example, the scan driver 123 may sequentially supply the scan signals to the scan lines S1 to Sp.

For connection with the scan lines S1 to Sq, the scan driver 123 may be directly mounted on the substrate on which the pixels PX are formed or may be connected to the substrate through a separate component such as a flexible circuit board.

The data driver 122 may generate the data signal by receiving a data driver control signal DCS and second image data DATA2 from the timing controller 121.

The data driver 122 may supply the generated data signal to the data lines D1 to Dq.

For connection with the data lines D1 to Dq, the data driver 122 may be directly mounted on the substrate on which the pixels PX are formed or may be connected to the substrate through a separate component such as a flexible circuit board.

When a scan signal is supplied to a specific scan line, some of the pixels PX connected to the specific scan line may receive the data signal transferred from the data lines D1 to Dq, and some of the pixels PX may emit light with a luminance corresponding to the received data signal.

The timing controller 121 may generate control signals for controlling the scan driver 123 and the data driver 122.

For example, the control signals may include the scan driver control signal SCS for controlling the scan driver 123 and the data driver control signal DCS for controlling the data driver 122.

The timing controller 121 may generate the scan driver control signal SCS and the data driver control signal DCS by using an external input signal.

For example, the external input signal may include a data enable signal DE and a vertical synchronization signal Vsync.

In addition, the timing controller 121 may supply the scan driver control signal SCS to the scan driver 123 and supply the data driver control signal DCS to the data driver 122.

The timing controller 121 may convert first image data DATA1 input from the outside (e.g., from outside of the display device 100) into the second image data DATA2 corresponding to a design specification of the data driver 122 and supply the second image data DATA2 to the data driver 122.

First image data DATA1 and second image data DATA2 may include luminance information of each of the pixels PX of the display panel 132, and the First image data DATA1 and the second image data DATA2 may be divided into frame units.

The data enable signal DE may be a signal defining a period in which valid data is input.

Although the scan driver 123, the data driver 122, and the timing controller 121 are shown as separate components in FIG. 3, at least some of the components may be integrated (e.g., combined) as needed.

An electrode to which a voltage and/or a signal for driving the display panel 132 is supplied may be referred to as a panel electrode. The panel electrode may be the data lines D1 to Dq, the scan lines S1 to Sq, the first power source ELVDD, the second power source ELVSS, and the like. A driving voltage may be supplied to the panel electrode. For example, a data voltage may be supplied to the data lines D1 to Dq, and a scan voltage may be supplied to the scan lines S1 to Sq.

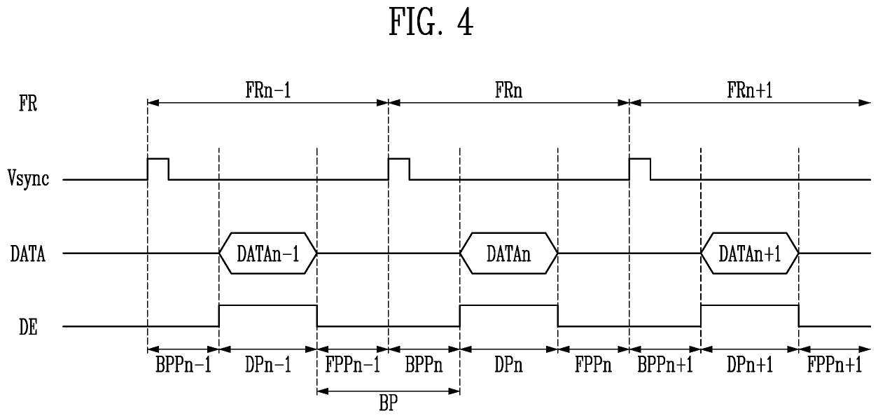

FIG. 4 is a timing diagram illustrating signals associated with the display driver of FIG. 3, according to some embodiments of the present disclosure.

Referring to FIG. 4, each frame period FR may include a display period DP in which the display panel 132 displays an image and a blank period BP in which the display panel 132 does not display an image.

The blank period BP may be disposed between the display periods DP. The blank period BP may include a front porch period FPP and a back porch period BPP.

The back porch period BPP may be between a time point when a frame period FR starts and a time point when the display period DP starts. The front porch period FPP may be between a time point when the display period DP ends and a time point when the frame period FR ends.

The vertical synchronization signal Vsync may define the frame period FR. The vertical synchronization signal Vsync may include a high level period and a low level period, and a period of the vertical synchronization signal Vsync may correspond to a period of the frame period FR.

In addition, a time point when the vertical synchronization signal Vsync transits to a high level may correspond to a time point when the frame period FR starts.

The data enable signal DE may define the blank period BP and the display period DP included in each of the frame periods FR. For example, the data enable signal DE may have a high level in the display period DP and have a low level in the blank period BP.

The data signal may be output from the data driver 122 of FIG. 3 while the data enable signal DE maintains the high level.

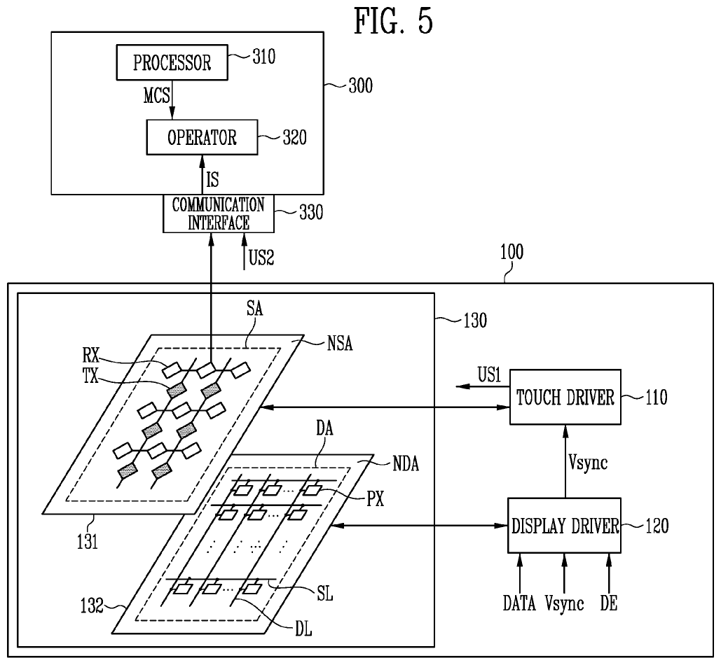

FIG. 5 is a block diagram illustrating an uplink process according to some embodiments of the present disclosure.

Referring to FIGS. 2 and 5, the display device 100 may include the touch driver 110, the display driver 120, and the panel 130. The panel 130 may include the touch panel 131 and the display panel 132. The touch panel 131 may include the sensing electrodes RX and the driving electrodes TX.

The external device 300 may include a processor 310, an operator 320, and a communication interface 330. In some embodiments, the external device 300 includes an active pen.

In FIG. 2, the first to p-th sensing electrodes RX1 to RXp and the first to q-th driving electrodes TX1 to TXq cross each other. Each sensing electrode and each driving electrode may be electrically separated from each other, and thus a mutual capacitance may be defined or formed between each sensing electrode and each driving electrode. As described above, mutual capacitances may be formed at portions where the first to p-th sensing electrodes RX1 to RXp and the first to q-th driving electrodes TX1 to TXq cross each other.

When the user's touch is provided to the touch panel 131, one or more of the mutual capacitances may change. For example, the user may include the external device, for example, the active pen. The touch may include at least one of various types of inputs that cause a change in a mutual capacitance, such as a user's physical contact (e.g., a user touch) or hovering. The touch driver 110 may recognize the touch by sensing such a change in the mutual capacitance.

The touch driver 110 is connected to the first to q-th driving electrodes TX1 to TXq through the first to q-th driving lines TXL1, TXL2, TXL3, . . . , TXL(q−1), and TXLq. The touch driver 110 is connected to the first to p-th sensing electrodes RX1 to RXp through the first to p-th sensing lines RXL1, RXL2, . . . , RXL(p−2), RXL(p−1), and RXLp.

The touch driver 110 may sense sensing signals from the first to p-th sensing electrodes RX1 to RXp through the first to p-th sensing lines RXL1 to RXLp while applying driving signals to the first to q-th driving electrodes TX1 to TXq through the first to q-th driving lines TXL1 to TXLq. The touch driver 110 may sense a change in the mutual capacitance based on the sensing signals.

In addition, the touch driver 110 may encode data indicating a position of each touch electrode and output an encoded data signal US1 to the external device 300 as an uplink signal US2 through a corresponding touch electrode. For example, the touch driver 110 may encode data corresponding to each of the first to q-th electrodes TX1 to TXq, and output the encoded data signal US1 as the uplink signal US2 through a corresponding driving electrode. In addition, the touch driver 110 may encode data corresponding to each of the first to p-th sensing electrodes RX1 to RXp, and output the encoded data signal US1 as the uplink signal US2 through a corresponding sensing electrode. Accordingly, the uplink signal US2 indicating different positions may be output through each touch electrode.

In some embodiments, the encoded data signal US1 and the uplink signal US2 further include information and the like, such as vertical synchronization signal Vsync information, panel information, and a protocol version. The external device 300 may obtain information on the vertical synchronization signal Vsync from the uplink signal US2, and thus determine a transmission time point of a downlink signal. In addition, the external device 300 may check the panel information or the protocol version from the uplink signal US2.

In some embodiments, the display driver 120 may transmit (e.g., periodically transmit) the vertical synchronization signal Vsync and/or information on the vertical synchronization signal Vsync to the touch driver 110. The touch driver 110 may output the uplink signal US2 through the touch electrodes RX and TX with reference to the vertical synchronization signal Vsync.

The external device 300 may receive the uplink signal US2 from the touch electrodes RX and TX when the external device 300 comes into contact with or approaches the touch electrodes RX and TX. As the external device 300 comes into contact with or approaches the touch electrodes RX and TX, an electric field may be generated between a communication interface 330 of the external device 300 and the touch electrodes RX and TX. When such an electric field is formed, a virtual capacitance may be formed between the external device 300 and the touch electrodes RX and TX. An impedance of the virtual capacitance may decrease as the external device 300 is close to the touch electrodes RX and TX. As the impedance of the virtual capacitance decreases, transmission of the uplink signal US2 from the touch electrodes RX and TX to the communication interface 330 of the external device 300 may be more desirable or advantageous. For example, the active pen may receive the uplink signal US2 from an adjacent driving electrode among the first to q-th driving electrodes TX1 to TXq, and receive the uplink signal US2 from an adjacent driving electrode among the first to p-th sensing electrodes RX1 to RXp. In this case, the active pen may decode the received uplink signals US2 to obtain position data of a corresponding driving electrode and position data of a corresponding sensing electrode. As described above, the active pen may determine a touch position coordinate of the active pen by decoding the received uplink signals US2. For these operations, the active pen may include the processor 310, the operator 320, and the communication interface 330.

The communication interface 330 transmitting the uplink signal US2 from the display device 100 may perform an operation of amplifying a corresponding signal. The uplink signal US2 amplified by the communication interface 330 may be transmitted to the operator 320 in a form of an input signal IS.

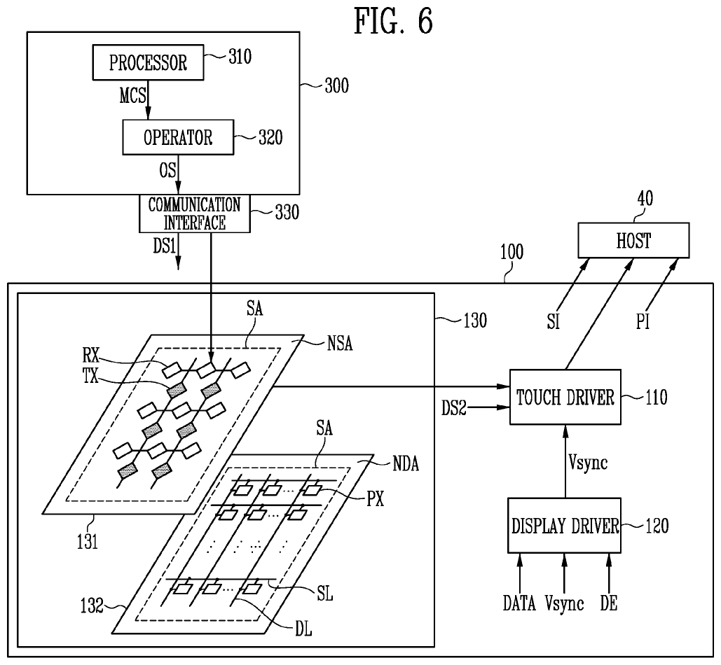

The processor 310 of the external device 300 may transmit an operator control signal MCS to the operator 320 to control an operation of the operator 320. In response to the operator control signal MCS, the operator 320 may decode the input signal IS to obtain the touch position coordinate on the touch panel 131 of the external device 300. The touch position coordinate may be a digital signal. In some embodiments, the processor 310 transfers the touch position coordinate to the touch driver 110 through the touch electrodes RX and TX of the display device 100 in a form of a downlink signal. In this case, the touch driver 110 may transfer the transferred touch position coordinate to a host 40 (e.g., refer to FIG. 6). In other embodiments, the active pen includes a communicator supporting wireless communication such as Bluetooth communication, and the processor 310 transfers the touch position coordinate to the host 40 through wireless communication using such a communicator.

In some embodiments, the host 40 is included in a computing device such as a computer, a notebook, a mobile phone, a smart phone, or a wearable device together with the display device 100. The host 40 may perform various operations using the obtained touch position coordinate.

The external device 300 may perform other operations using the touch position coordinate.

FIG. 6 is a block diagram illustrating a downlink process according to some embodiments of the present disclosure.

Referring to FIG. 6, the display device 100 may include the touch driver 110, the display driver 120, and the panel 130. The panel 130 may include the touch panel 131 and the display panel 132. The touch panel 131 may include the sensing electrodes RX and the driving electrodes TX. Hereinafter, descriptions overlapping that of FIG. 5 are omitted for clarity of description and brevity purposes.

The processor 310 of the external device 300 may transmit the operator control signal MCS to the operator 320 to control the operation of the operator 320. In response to the operator control signal MCS, the operator 320 may decode the input signal IS (e.g., refer to FIG. 5) to obtain the touch position coordinate on the touch panel 131 of the external device 300. The touch position coordinate may be a digital signal.

The operator 320 may transmit the touch position coordinate to the communication interface 330 in a form of an output signal OS.

The communication interface 330 transmitting the output signal OS from the operator 320 may amplify a corresponding signal.

The output signal OS amplified by the communication interface 330 may be transmitted to the touch electrodes RX and TX in a form of a downlink signal DS1.

As the external device 300 comes into contact with or approaches the touch electrodes RX and TX, an electric field may be generated between the communication interface 330 of the external device 300 and the touch electrodes RX and TX. When such an electric field is formed, a virtual capacitance may be formed between the external device 300 and the touch electrodes RX and TX. An impedance of the virtual capacitance may decrease as the external device 300 is close to the touch electrodes RX and TX. As the impedance of the virtual capacitance decreases, transmission of the downlink signal DS1 from the external device 300 to the touch electrodes RX and

TX may be more advantageous. For example, the active pen may transmit the downlink signal DS1 to an adjacent driving electrode among the first to q-th driving electrodes TX1 to TXq, and transmit the downlink signal DS1 to an adjacent sensing electrode among the first to p-th sensing electrodes RX1 to RXp.

The touch electrodes RX and TX receiving the downlink signal DS1 from the communication interface 330 may transfer a corresponding downlink signal DS2 to the touch driver 110.

The touch driver 110 receiving the downlink signal DS2 including the touch position coordinate PI may transfer the touch position coordinate PI to the host 40. In some embodiments, the downlink signal DS1 further includes state information S1 of the external device 300, such as a button state (e.g., a pressed or depressed state of a button), a battery state (e.g., a state of charge or state of health of a battery), and a slope (e.g., contact angle) when the external device 300 contacts the touch panel 131. In this case, the touch driver 110 may extract the state information S1 of the external device 300 from the downlink signal DS2, and transfer the extracted state information S1 of the external device 300 to the host 40. In some embodiments, the display device 100 and the host 40 performs wired communication with each other. In other embodiments, the display device 100 and the host 40 perform wireless communication with each other.

The processor 310 may refer to the vertical synchronization signal Vsync information included in the uplink signal US2, and determine a time point when the output signal OS is transmitted from the operator 320 to the touch electrodes RX and TX in consideration of a time point when the external device 300 or the active pen contacts or approaches the touch electrodes RX and TX. The processor 310 may generate the operator control signal MCS according to the determined time point. The operator 320 may transmit the downlink signal DS1 to the touch electrodes RX and TX through the communication interface 330 in response to the operator control signal MCS.

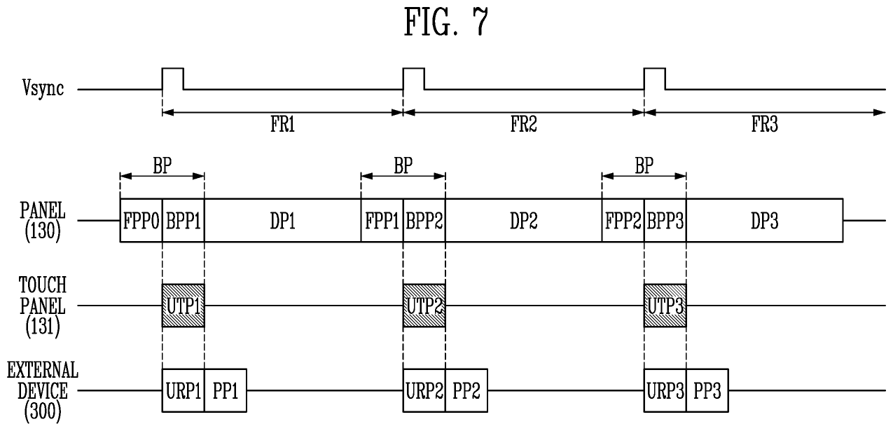

FIG. 7 is a timing diagram illustrating the operation of the display device in the uplink process of FIG. 5, according to some embodiments of the present disclosure.

A parasitic capacitance may be formed between the panel electrodes and the touch electrodes RX and TX. The parasitic capacitance may function as a factor that hinders transmission and reception of a signal between the touch electrodes RX and TX and the external device 300. In some embodiments, the panel electrodes includes the data lines D1 to Dq, the scan lines S1 to Sq, the first power source ELVDD, the second power source ELVSS, and the like of FIG. 3.

The display device 100 may improve a signal characteristic of the uplink signal by reducing (e.g., minimizing) an effect of the parasitic capacitance on transmission of the uplink signal.

Referring to FIGS. 5 and 7, each frame period may include the display period in which the display panel 132 displays an image and the blank period BP in which the display panel 132 does not display an image. For example, a first frame period FR1 may include a first display period DP1 and the blank period BP. A second frame period FR2 may include a second display period DP2 and the blank period BP. Similarly, a third frame period FR3 may include a third display period DP3 and the blank period BP.

Each blank period BP may be disposed between the first to third display periods DP1, DP2, and DP3. For example, a blank period BP may be between the first and second periods DP1 and DP2, and another blank period BP may be between the second and third periods DP2 and DP3. Each blank period BP may include a front porch period and a back porch period. For example, the blank period BP of the first frame period FR1 includes a first back porch period BPP1 and a first front porch period FPP1. The blank period BP of the second frame period FR2 includes a second back porch period BPP2 and a second front porch period FPP2. The third frame period FR3 includes a third back porch period BPP3 and a third front porch period. A 0-th front porch period FPP0 of FIG. 7 may be included in a 0-th frame period before the first frame period FR1.

Each of the first to third back porch periods BPP1, BPP2, and BPP3 may be between a time point when a corresponding frame period starts and a time point when a corresponding display period starts. The first to third front porch periods FPP1 and FPP2 may be between a time point when a corresponding display period ends and a time point when a corresponding frame period ends.

The vertical synchronization signal Vsync may define the first to third frame periods FR1, FR2, and FR3. The vertical synchronization signal Vsync may include a high level period and a low level period, and a period of the vertical synchronization signal Vsync may correspond to a period of the first to third frame periods FR1, FR2, and FR3. For example, as shown in FIG. 7, a time point when the high level period of the vertical synchronization signal Vsync starts may correspond to a time point when each of the first to third frame periods FR1, FR2, and FR3 starts.

A period in which the uplink signal US2 is transmitted from the touch panel 131 to the external device 300 may be defined as an uplink signal transmission period. As shown in FIG. 7, the first to third frame periods FR1, FR2, and FR3 may include first to third uplink signal transmission periods UTP1, UTP2, and UTP3, respectively.

A period in which the external device 300 receives the uplink signal from the touch panel 131 may be defined as an uplink signal reception period. As shown in FIG. 7, the first to third uplink signal reception periods URP1, URP2, and URP3 UTP2, and UTP3 may be provided.

A period in which the operator 320 of the external device 300 calculates the touch position coordinate of the external device 300 included in the input signal IS respectively corresponding to the first to third uplink signal transmission periods UTP1, through decoding may be defined as a processing period. As shown in FIG. 7, a corresponding input signal IS is processed during a first processing period PP1 after the first uplink signal reception period URP1. A corresponding input signal S1 is processed during a second processing period PP2 after the second uplink signal reception period URP2. A corresponding input signal IS is processed during a third processing period PP3 after the third uplink signal reception period URP3.

The display device 100 may reduce (e.g., minimize) an effect of the parasitic capacitance on transmission of the uplink signal US2 by transmitting the uplink signal US2 in the blank period BP in which the display panel 132 does not display an image, thereby improving a signal characteristic of the uplink signal US2.

In some embodiments, the first to third uplink signal transmission periods UTP1, UTP2, and UTP3 overlap the first to third back porch periods BPP1, BPP2, and BPP3, respectively. In some embodiments, the first to third uplink signal transmission periods UTP1, UTP2, and UTP3 are included in the first to third back porch periods BPP1, BPP2, and BPP3, respectively.

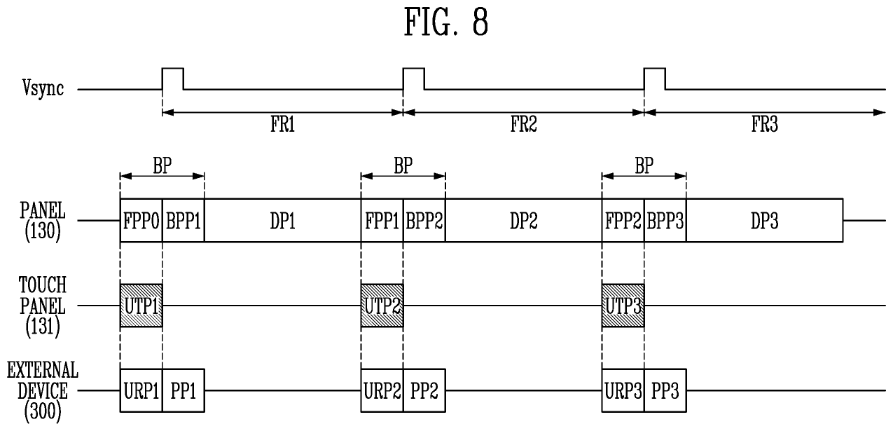

FIG. 8 is a timing diagram illustrating the operation of the display device in the uplink process of FIG. 5, according to some other embodiments of the present disclosure.

Referring to FIG. 8, differently from FIG. 7, the first to third uplink signal transmission periods UTP1, UTP2, and UTP3 may overlap the 0-th to second front porch periods FPP0, FPP1, and FPP2, respectively. In some embodiments, the first to third uplink signal transmission periods UTP1, UTP2, and UTP3 are included in the 0-th to second front porch periods FPP0, FPP1, and FPP2, respectively. Accordingly, the first to third uplink signal reception periods URP1 to URP3 may also be included in the 0-th to second front porch periods FPP0, FPP1, and FPP2.

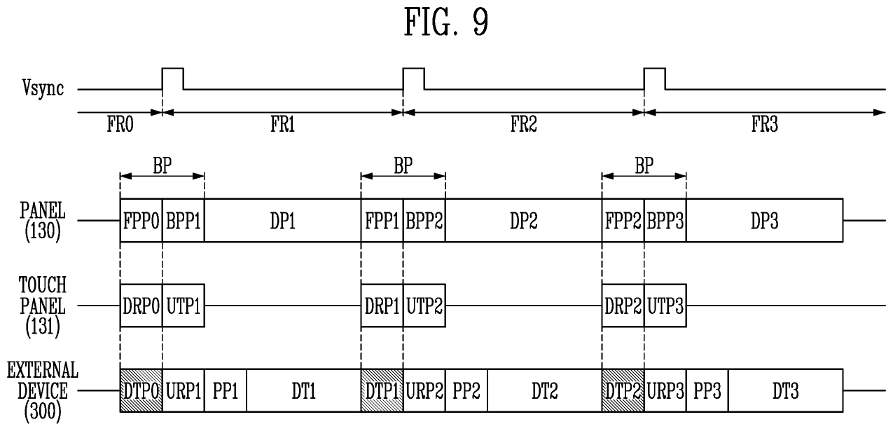

FIG. 9 is a timing diagram illustrating the operation of the display device in the downlink process of FIG. 6, according to some embodiments of the present disclosure.

A parasitic capacitance may be formed between the panel electrodes and the touch electrodes RX and TX. The parasitic capacitance may function as a factor that hinders transmission and reception of a signal between the touch electrodes RX and TX and the external device 300.

The display device 100 may improve a signal characteristic of the downlink signal by reducing (e.g., minimizing) an effect of the parasitic capacitance on transmission of the uplink signal.

Each frame period may include the display period in which the display panel 132 displays an image and the blank period BP in which the display panel 132 does not display an image. For example, a first frame period FR1 may include a first display period DP1 and the blank period BP. A second frame period FR2 may include a second display period DP2 and the blank period BP. Similarly, a third frame period FR3 may include a third display period DP3 and the blank period BP. Hereinafter, description overlapping those of FIGS. 7 and 8 are omitted for clarity of description and brevity purposes.

A period in which the external device 300 transmits the downlink signal to the touch panel 131 may be defined as a downlink signal transmission period. As shown in FIG. 9, 0-th to second frame periods FR0, FR1, and FR2 may include 0-th to second downlink signal transmission periods DTP0, DTP1, and DTP2, respectively.

A period in which the touch panel 131 receives the downlink signal may be defined as a downlink signal reception period. As shown in FIG. 9, 0-th to second downlink signal reception periods DRP0, DRP1, and DRP2 respectively corresponding to the 0-th to second downlink signal transmission periods DTP0, DTP1, and DTP2 may be provided.

A period in which the operator 320 of the external device 300 calculates the touch position coordinate of the external device 300 included in the input signal IS through decoding may be defined as a processing period. As shown in FIG. 9, a corresponding input signal IS is processed during a first processing period PP1 after the first uplink signal reception period URP1. A corresponding input signal S1 is processed during a second processing period PP2 after the second uplink signal reception period URP2. A corresponding input signal IS is processed during a third processing period PP3 after the third uplink signal reception period URP3.

A period from a time point when the processing period PP ends to a time point when the downlink signal transmission period starts may be defined as a delay period. As shown in FIG. 9, a first delay period DT1 exists after the first processing period PP1 and before the first downlink signal transmission period DTP1. A second delay period exists after the second processing period PP2 and before the second downlink signal transmission period DTP2.

A third delay period DT3 exists after the third processing period PP3 and before the third downlink signal transmission period DTP3.

The external device 300 may reduce (e.g., minimize) an effect of the parasitic capacitance on transmission of the downlink signal by transmitting the downlink signal in the blank period BP in which the display panel 132 does not display an image, thereby improving a signal characteristic of the downlink signal.

In some embodiments, the 0-th to second downlink transmission periods DTP0, DTP1, and DTP2 are included in the 0-th to second front porch periods FPP0, FPP1, and FPP2, respectively. In this case, the first to third uplink signal transmission periods UTP1, UTP2, and UTP3 may be included in the first to third back porch periods BPP1, BPP2, and BPP3, respectively.

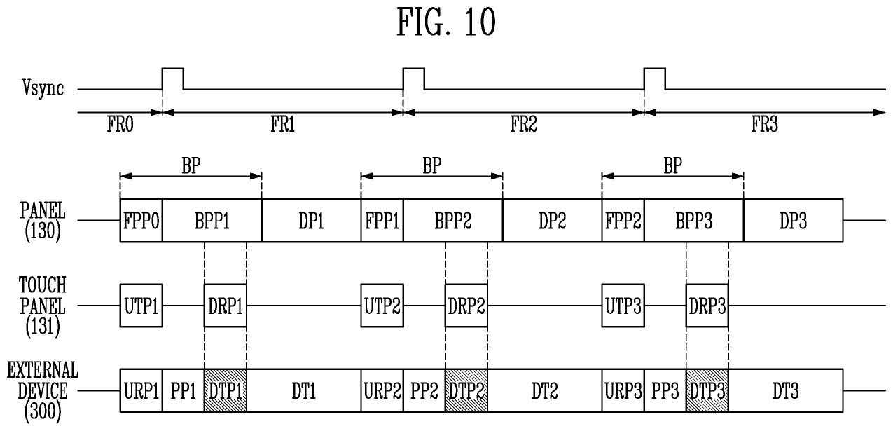

FIG. 10 is a timing diagram illustrating the operation of the display device in the downlink process of FIG. 6, according to some other embodiments of the present disclosure.

Referring to FIG. 10, differently from FIG. 9, the first to third uplink signal transmission periods UTP1, UTP2, and UTP3 are included in the 0-th to second front porch periods FPP0, FPP1, and FPP2, respectively. Accordingly, the first to third uplink signal reception periods URP1, URP2, and URP3 respectively corresponding to the first to third uplink signal transmission periods UTP1, UTP2, and UTP3 may also be included in or overlap the 0-th to second front porch periods FPP0, FPP1, and FPP2.

After each uplink signal reception period, a processing period PP for a corresponding uplink signal is required. Accordingly, as shown in FIG. 10, the first to third processing periods PP1, PP2, and PP3 may be included in the first to third back porch periods BPP1, BPP2, and BPP3, respectively.

After the first processing period PP1, the external device 300 may output the downlink signal (e.g., refer to DS1 of FIG. 6) in the first downlink transmission period DTP1. After the second processing period PP2, the external device 300 may output the downlink signal in the second downlink transmission period DTP2. After the third processing period PP3, the external device 300 may output the downlink signal in the third downlink transmission period DTP3. At this time, the first to third downlink transmission periods DTP1, DTP2, and DTP3 may be included in the first to third back porch periods BPP1, BPP2, and BPP3, respectively.

In the external device 300, a delay period DT exists between a time point when the downlink transmission period DTP ends and a time point when the uplink reception period URP starts. For example, a first delay period DT1 exists between a time point when the first downlink transmission period DTP1 ends and a time point when the second uplink reception period URP2 starts.

A second delay period DT2 exists between a time point when the second downlink transmission period DTP2 ends and a time point when the third uplink reception period URP3 starts.

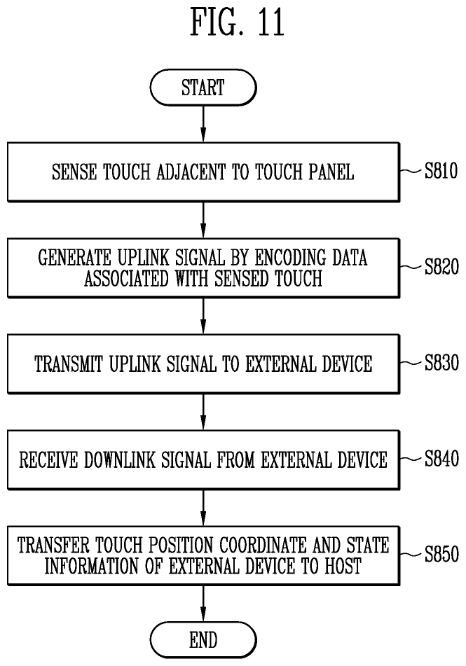

FIG. 11 is a flowchart illustrating a method of operating a display device according to some embodiments of the present disclosure.

Referring to FIG. 11, in S810, the display device 100 may sense a touch adjacent to the touch panel 131.

In S820, the display device 100 may generate the encoded data signal US1 and uplink signal US2 by encoding data indicating a position of each touch electrode. The encoded data signal US1 and uplink signal US2 may further include information such as vertical synchronization signal Vsync information, panel information, and a protocol version.

In S830, the display device 100 may transmit the uplink signal US2 indicating different touch positions of the external device 300 to the external device 300. The uplink signal transmission period UTP (e.g., refer to FIGS. 7 and 8) may be included in the blank period BP (e.g., refer to FIGS. 7 and 8).

In S840, the display device 100 may receive the downlink signal DS1 from the external device 300. The downlink signal DS1 may include the touch position coordinate PI on the touch panel 131 of the external device 300 obtained through decoding by the external device 300. The downlink signal DS1 may further include the state information S1 of the external device 300. The state information S1 may include a button state (e.g., a pressed or depressed state of a button) of the external device 300, a battery state (e.g., a state of charge or state of health of a battery), an inclination angle (e.g., contact angle) during the contact on the touch panel 131, and the like. The downlink signal reception period DRP (e.g., refer to FIGS. 9 and 10) may be included in the blank period BP (e.g., refer to FIGS. 9 and 10).

In S850, the display device 100 may transfer the touch position coordinate PI to the host 40. At this time, the display device 100 may transmit state information S1 of the external device 300 to the host 40.

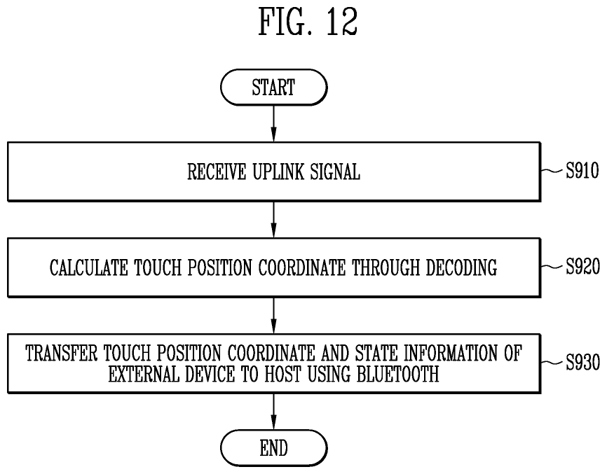

FIG. 12 is a flowchart illustrating a method of operating the external device, according to some embodiments of the present disclosure.

In S910, the external device 300 may receive the uplink signal US2 from the display device 100. The uplink signal US2 may be generated by the display device 100. The uplink signal transmission period UTP (e.g., refer to FIGS. 7 and 8) may be included in the blank period BP. Accordingly, the uplink signal reception period URP (e.g., refer to FIGS. 7 and 8) may also be included in the blank period BP.

In S920, the external device 300 may obtain the touch position coordinate PI on the touch panel 131 of the external device 300 through decoding. The touch position coordinate PI may be a digital signal.

In S930, the external device 300 may include a communicator supporting wireless communication such as Bluetooth communication, and may transfer the touch position coordinate PI to the host 40 through the wireless communication using the communicator. Similarly, the external device 300 may transfer the state information S1 of the external device 300 to the host 40 through the wireless communication using the communicator.

As described above, according to some embodiments, the signal characteristic of the uplink signal transmitted to the external device 300 and the signal characteristic of the downlink signal received from the external device 300 are improved without increasing power consumption.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the terms “use,” “using,” and “used” may be considered synonymous with the terms “utilize,” “utilizing,” and “utilized,” respectively.

When one or more embodiments may be implemented differently, a specific process order may be performed differently from the described order. For example, (i) the disclosed operations of a process are merely examples, and may involve various additional operations not explicitly covered, and (ii) the temporal order of the operations may be varied.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The display device, the external device, and/or any other relevant devices or components according to embodiments of the present invention described herein may be implemented utilizing any suitable hardware, firmware (e.g., an application-specific integrated circuit), software, or a suitable combination of software, firmware, and hardware. For example, the various components of the display device may be formed on one integrated circuit (IC) chip or on separate IC chips. Further, the various components of the display device may be implemented on a flexible printed circuit film, a tape carrier package (TCP), a printed circuit board (PCB), or formed on a same substrate. Further, the various components of the display device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A display device comprising:
a display panel comprising a plurality of pixels;
a display driver configured to display an image on the display panel in a frame period unit, to display the image on the display panel in a display period of the frame period, and to not display the image in a blank period of the frame period;
a touch panel comprising touch electrodes; and
a touch driver configured to sense a touch adjacent to the touch panel via the touch electrodes, and to transmit an uplink signal to an external device through the touch electrodes in a first time period, the first time period being in the blank period.

2. The display device according to claim 1, wherein the blank period comprises a first porch period between a time point when the frame period starts and a time point when the display period starts, and a second porch period between a time point when the display period ends and a time point when the frame period ends, and
wherein the first time period is in the first porch period.

3. The display device according to claim 1, wherein the blank period comprises a first porch period between a time point when the frame period starts and a time point when the display period starts, and a second porch period between a time point when the display period ends and a time point when the frame period ends, and
wherein the first time period is in the second porch period.

4. The display device according to claim 1, wherein in a second time period after the first time period, the touch driver is configured to receive a downlink signal from the external device through the touch electrodes.

5. The display device according to claim 4, wherein the first time period is part of a first frame period among a plurality of frame periods formed by repetition of the frame period,
wherein the blank period comprises a first porch period between a time point when a corresponding frame period among the plurality of frame periods starts and a time point when the display period of the corresponding frame period starts, and a second porch period between a time point when the display period of the corresponding frame period ends and a time point when the corresponding frame period ends,
wherein the first time period is in the first porch period of the first frame period, and
wherein the second time period is in the second porch period of the first frame period.

6. The display device according to claim 4, wherein the first time period is part of a first frame period among a plurality of frame periods formed by repetition of the frame period,
wherein the blank period comprises a first porch period between a time point when a corresponding frame period among the plurality of frame periods starts and a time point when the display period of the corresponding frame period starts, and a second porch period between a time point when the display period of the corresponding frame period ends and a time point when the corresponding frame period ends,
wherein the first time period is in the second porch period of the first frame period, and
wherein the second time period is in the first porch period of a second frame period immediately after the first frame period among the plurality of frame periods.

7. The display device according to claim 4, wherein the external device is an active pen, and
wherein the downlink signal comprises at least one of a position coordinate of the active pen, button state information of the active pen, tilt information of the active pen, and battery state information of the active pen.

8. A method of driving a display device comprising a display panel and a touch panel, the method comprising:
sensing a touch adjacent to the touch panel;
generating an uplink signal by encoding data associated with the sensed touch; and
transmitting the uplink signal to an external device through touch electrodes of the touch panel in a first time period,
wherein the first time period is in a blank period in which the display panel does not display an image.

9. The method according to claim 8, wherein the display panel displays the image in a frame period unit,
wherein the frame period comprises a display period in which the display panel displays the image and the blank period,
wherein the blank period comprises a first porch period between a time point when the frame period starts and a time point when the display period starts, and a second porch period between a time point when the display period ends and a time point when the frame period ends, and
wherein the first time period is in the first porch period.

10. The method according to claim 8, wherein the display panel displays the image in a frame period unit,
wherein the frame period comprises a display period in which the display panel displays the image and the blank period,
wherein the blank period comprises a first porch period between a time point when the frame period starts and a time point when the display period starts, and a second porch period between a time point when the display period ends and a time point when the frame period ends, and
wherein the first time period is in the second porch period.

11. The method according to claim 8, further comprising:
receiving a downlink signal from the external device through the touch electrodes of the touch panel in a second time period after the first time period.

12. The method according to claim 11, wherein the first time period is part of a first frame period among a plurality of frame periods formed by repetition of the frame period,
wherein the blank period comprises a first porch period between a time point when a corresponding frame period among the plurality of frame periods starts and a time point when a display period of the corresponding frame period starts, and a second porch period between a time point when the display period of the corresponding frame period ends and a time point when the corresponding frame period ends,
wherein the first time period is in the first porch period of the first frame period, and
wherein the second time period is in the second porch period of the first frame period.

13. The method according to claim 11, wherein the first time period is part of a first frame period among a plurality of frame periods formed by repetition of the frame period,
wherein the blank period comprises a first porch period between a time point when a corresponding frame period among the plurality of frame periods starts and a time point when a display period of the corresponding frame period starts, and a second porch period between a time point when the display period of the corresponding frame period ends and a time point when the corresponding frame period ends,
wherein the first time period is in the second porch period of the first frame period, and
wherein the second time period is in the first porch period of a second frame period immediately after the first frame period among the plurality of frame periods.

14. The method according to claim 11, wherein the external device is an active pen, and
wherein the downlink signal comprises at least one of a position coordinate of the active pen, button state information of the active pen, tilt information of the active pen, and battery state information of the active pen.

15. The method according to claim 8, further comprising:
transmitting a position coordinate corresponding to the touch extracted from the uplink signal received by the external device, and state information of the external device from the external device to a host via a wireless connection.
